(19) United States
(12) Patent Application Publication
(10) Pub. No.: US 2008/0189175 A1
(43) Pub. Date: Aug. 7, 2008

(54) Method and System for In-Depth Advertising for Interactive Gaming

(75) Inventor: Dominic Koman Chan, Los Angeles, CA (US)

Correspondence Address: ALLAN LAW GROUP, PROFESSIONAL CORPORATION, 22917 PACIFIC COAST HWY, SUITE 350, MALIBU, CA, 90265, US

(73) Assignee: IC.COM, INC.

(21) Appl. No.: 11/670,231

(22) Filed: Feb. 1, 2007

(51) Int. Cl. G06Q 30/00

(52) U.S. Cl. 705/14

(57) ABSTRACT

The present invention relates to a method and system for advertisements to be sent, received and understood by recipients in a conducive matter in an interactive computer game environment. After one or more advertisements are displayed, the game player is interactively asked questions about the product or service, which when correctly responded to allows the player to earn rewards, including “gadgets” for improving performance in a game, or other benefits to the player. A correct answer to product or service-related questions signifies that the player comprehends the message integrated into the question. By properly framing the questions and providing for clues under certain circumstances, even complex or brand messages can be effectively communicated and verified to have been understood by the recipient.

### FIELD OF THE INVENTION

The present invention relates generally to a method and system for ensuring and verifying that the message in electronic advertising is received and understood by the recipient. More particularly, the present invention is a method and system of integrating advertising and its intended message into interactive computer games such that the game player receives benefits for viewing the advertising message and correctly responding to questions, which verify that the message has been received and understood by the game player.

### BACKGROUND OF THE INVENTION

It is well known in the advertising industry that conventional advertising with no interactive capabilities such as television, radio and print cannot effectively attract or capture the attention of young people because of their short attention span and large number of distractions. For this reason the Internet and the World Wide Web have been a rapidly growing medium for advertisers attempting to interactively promote their goods and services to the young. However, Internet advertising has limitations and cannot ensure that a young person has received or understood the advertising message. On the Internet, advertisers often populate portions of the screen with banner margin pop-up, pop-back, slide, and/or fly ads. Some of these advertisements employ animated features, objects, or characters to entice the computer user to click the ad. Studies, however, have shown that as the novelty of the Internet wears-off, all of these advertising schemes lose effectiveness, as witnessed by the continued decline in rates for these advertisements and the progression away from counting the number of “views” to actual “click results.” Yet even for “clicks,” which refers to a user clicking on a portion of an advertisement to be led to a different web location, typically the web site of the advertiser, the advertising provider has no assurance that the computer user has understood the contents of the advertisement even if the computer user clicks on it. For example, the computer user may only be enticed by prizes or an attractive picture and may be entirely uninterested in the destination to which the click brings the computer user.

Additionally, current means of Internet advertising also suffers because a regular computer user may develop the habit of ignoring extraneous matter, particularly advertising. The ads can be annoying and disruptive, especially pop-up ads, to the purpose for which the computer user has visited the Internet site.

In light of this, advertising providers sought means to become relevant to the young people in order to attract attention. One of the most popular activities for the young on the Internet is game playing. Realizing this, there have been attempts to place advertising in computer games. One method is simply to display advertising “banners” (background or side panels on the computer screens containing advertising messages displayed before, after or during a game) or “pop-ups” (automatic activation of a new window containing advertising messages according to some pre-determined conditions before, after or during a game). In practice, one or a plurality of advertisements is downloaded from a remote host to a computer user's local host when the game player or gamer, initiates the game. Sometimes a code relating to the game is uploaded to the game service provider, such information then serving as a parameter(s) for advertisements to be downloaded and presented on the gamer's screen. One or more advertisements can presented on the gamer's screen at certain predetermined times during the operation of the game and/or at the end of the game or in response to certain episodes in the game or certain actions taken by the gamer.

Another method is the use of “adver-games,” which are small games designed specifically for an advertiser and typically displayed in the advertisers' web site to attract visitors. Advertising messages may be built into the game, such as a racing game using the logo of a car to be promoted Adver-games may also contain banner or pop-up advertising panels as described.

Product placement within computer games is difficult and uneconomical. Embedding an advertiser's product within a game, such as placing a special pair of the advertiser's sport sneakers into a game character so that the game character can run faster, is limiting. Software for the game must be customized to accommodate such feature(s) and such system does not allow the ability to easily or cost-effectively interchange differing products or services.

Both of these methods still have significant shortcomings, foremost that garners consider the appearance of advertising messages to be intrusive into their game-playing and would try to ignore them. For those advertisement mechanisms so intrusive that they cannot be ignored, the result can be worse because they can be considered pests and alienate rather than attract the ultimate target. Thus, while the advertising reaches the gamers, the advertising provider lacks assurance that the gamer has processed or understood the content or essence of the advertising and often incurs the ire of the intended recipients.

Verification that an Internet message to the young has been received and understood is made even more difficult by the fact that many young people do not own their own computers. They access the Internet through public computers, such as those in public schools or libraries, or via commercial computers, such as those in Internet cafés. The transitory nature of this group of computer users relative to any one physical computer makes it impossible to identify a person by the IP address and presents a great challenge for advertising providers to obtain marketing feedback or perform effectiveness studies for their campaigns.

What is needed therefore is a method and system for advertising on the Internet to reach young people, which provides assurance that the user receives, comprehends and welcomes the advertiser's message.

### SUMMARY OF THE INVENTION

The present invention overcomes the deficiencies noted in the current art, and provides a method and system for advertiser messages to be sent, received and understood by young people in a conducive matter. Broadly according to the invention, the technique is to query a young computer gamer with questions about an advertised product or service. The gamer is rewarded for providing correct answers. The reward can be in different forms.

One form of rewards is to allow the gamer to earn “gadgets” which are virtual tools for use to improve the changes of a player performing well in games. Virtually every popular computer or online game involves gadgets. Some examples include furnishing a magic sword in a war game, extra fuel in a racing game or exceptional strength in a fighting game. The value of gadgets are widely accepted by gamers. Some of the most successful massively multi-player online role playing games (“MMORG”) with tens of millions of dollars in annual revenues have changed from a “pay per play,” “pay per unit time,” or “pay per month” model to a “play for free but pay per gadget” model acknowledging the importance of gadgets. By performing well in the games, the gamer may win virtual or physical prizes or privileges, which include any advantages bestowed to the gamer not generally available to other players that enhance the gamer's experience. Examples include a shorter waiting line for a popular destination, earlier notification of relevant information, “tickets” to special bidding, and titles or kudos signifying stature.

The gamer can be rewarded by directly earning points, which can be accumulated to exchange or bid for virtual or physical prizes or privileges. The gamer can also be rewarded by being given opportunities to earn game pieces which can be collected and assembled to win virtual or physical prizes or privileges. The more correct answers and responses to advertiser questions, the more rewards the gamer receives and the more likely the gamer will win virtual or physical prizes or privileges.

A correct answer to a product-related question signifies that the player not only has received, but indeed comprehends the message integrated into the question. By properly framing the questions and clues provided under certain circumstances, even complex or brand messages can be effectively communicated and verified to have been understood by the recipient.

The gamer is therefore encouraged and induced by the rewards to provide correct answers to these questions. By inducing the gamers to concentrate on questions and assert efforts in providing answers, the advertisers can receive statistics and affirmative information that their advertising messages have been sent, received, and understood. Based on metrics that advertisers receive from these interactions, advertisers have the ability to tailor, modify and refine their advertising so that it can be better understood and more effective. Marketers can utilize the invention to query people regarding their opinions, tastes, and preferences.

This invention also encompasses a configuration in which some or all of the games questions, answers, gadgets or other relevant elements described above have been pre-loaded on the local computer or storage devices accessible by the gamer, as long as there is an effective return path which allows the game provider to collect relevant information on the questions and answers. This invention is not confined to the Internet, but applies equally to other forms of interactive gaming platforms, including client-server system, Intranet, interactive television, electronic magazines with an effective return path, and other similar interactive platforms with a return path.

In this inventive disclosure, the concept of “game” is extended beyond any existing forms of computer games including any interactive set of rules involving skill, chance or a combination of both, whether single person or multiple persons, two-dimensional or higher dimensions. Similarly, the concept of “reward” is not confined to any rewards listed, but any advantages or benefits that a game-player enjoys whether playing the game (such as a gadget) or thereafter (such as a physical prize).

This invention also discloses a new type of pricing model for interactive advertisers or marketers, including but not limited to those who advertise on the Internet. Rather than charging per view, insert, or click-through, which all stop short of ensuring reception and understanding of the advertised message, this invention now establishes a new type of pricing for the number of correct answers chosen by a gamer. The model reflects messages received and understood and is far more valuable to an advertiser.

### BRIEF DESCRIPTION OF THE DRAWINGS

FIG. 1 is a flow diagram which shows one embodiment to illustrate the steps taken to employ the invention to ensure that a user receives and understands an advertising message while the user is playing an interactive computer game.

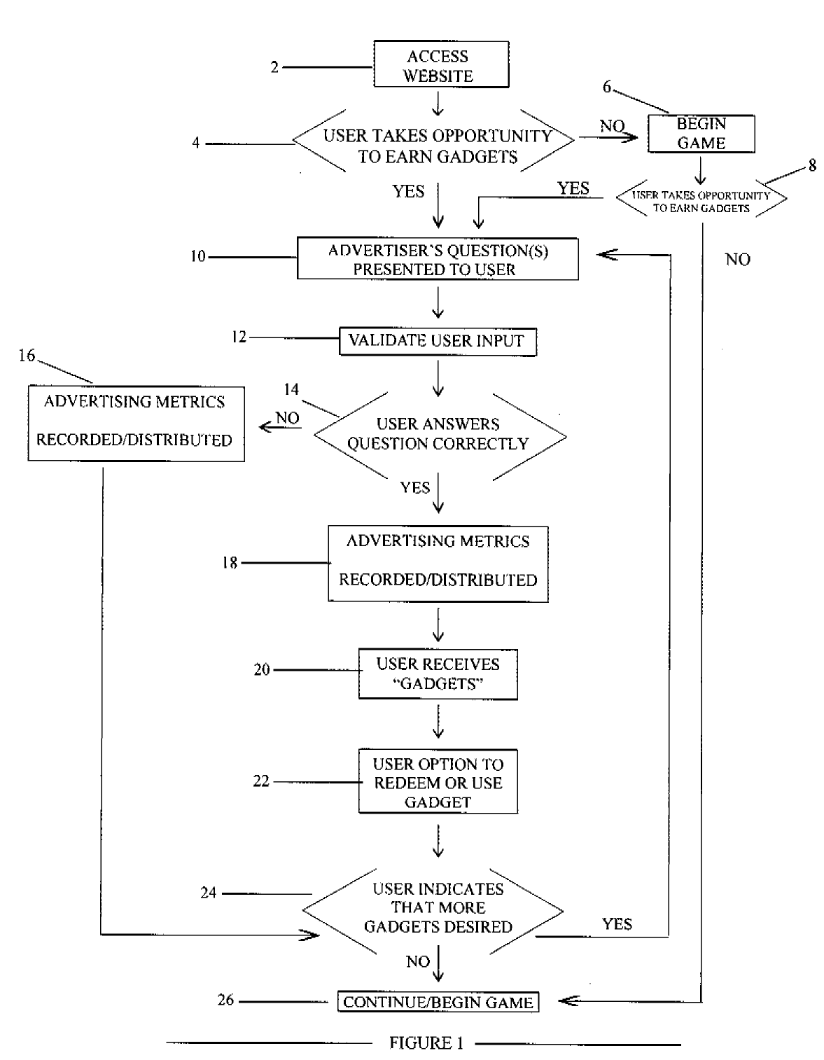

FIG. 2 depicts one embodiment of a configuration of servers, storage devices, and user processors connected to a local area network (“LAN”) and to the Internet or Wide Area Network consistent with the present invention.

### DETAILED DESCRIPTION

The invention addresses a problem of reaching a person with advertising and knowing that important advertiser messages are sent, received and understood. In a preferred embodiment of the invention, the advertising message is displayed to an individual, that is a user or gamer, who plays interactive games, specifically computer games, on the Intranet or Internet at an Internet café. The Internet café will likely have a plurality of user processors, i.e. computers, connected on a local area network (“LAN”). At least one server with Internet access has connectivity to the LAN. The server can include a communication gateway and/or firewall. Each user processor, also referred to as a “client processor” or “computer,” has a display device such as a monitor and an input mechanism such as a keyboard, mouse, touchpad, trackball, and/or joystick. The user processors will each have read/write access to a storage device/storage medium such as a hard disk connected to a file server on the LAN.

The gamer could be of any age but will likely be a young person, a member of a group that many advertisers try to reach. Using an input device, the gamer accesses the website containing the desired computer game, also referred to as an “interactive game” or “game,” 2 or otherwise interacts with the in-game area. There is no up-front charge or fee for the gamer to invoke the game. The gamer need not purchase game tokens.

The gamer is presented with the opportunity to earn rewards prior to 4, during, or after playing an interactive game by responding correctly to one or more interrogatories or questions pertaining to an electronic advertisement, also referred to as an “electronic advertising message.” This is a gamer opt-in decision, one that need not be exercised by the gamer prior to starting the game. The electronic advertisement could be a marketing insert to solicit one or more opinions from the gamer.

The gamer initiates the game 6. The game is one for leisure and fin. The game is not an infomercial for a product or service. In the preferred embodiment, the game is accessible via the Intranet. The files and/or executables and/or advertising content for the game reside on the storage device connected to the file server on the Intranet.

During the game, the gamer is given at least one opportunity to earn one or more rewards, such as gadgets 8. If the gamer decides against trying to earn one or more rewards when the opportunity arises, then the gamer can continue playing the game 26. If, on the other hand, the gamer decides to try to earn rewards, then the gamer is presented with one or more interrogatories, such as questions 10 pertaining to information in an advertisement presented to the user. In a preferred embodiment, the interrogatory will include a clue enabling the gamer to search for the answer. The interrogatory, however, need not contain clues.

The advertisements and interrogatories have already been downloaded to the file server, so they can rapidly be accessed during the game play with a minimum of delay experienced by the gamer.

The gaming software validates the gamer's input to determine whether or not the gamer answered the interrogatory correctly 12. A validation database resides on the file server.

The gaming program records the gamer's response, also referred to as the “response” or “user response,” regardless of whether it is a correct 18 or incorrect 16 answer. The responses are recorded on the storage medium such as a hard disk at the local file server for future reference by the promoter of the advertisement or the advertisers. The gamer's responses are preserved on the storage medium after the completion of the game. On a timed basis during off-business hours, the responses are automatically uploaded to the advertising provider's remote host. Updated interrogatories, answers, and advertisements are downloaded to the local file server.

If the gamer answers the interrogatory correctly 14, the gamer receives a reward, in this case a gadget for additional time to play the interactive game 20. The gamer can then redeem the gadget 22 or accumulate additional gadgets 24. The garner can save the gadgets, whether earned prior to, during, or after the game.

If the gamer elects to earn more gadgets, then the garner must respond to additional interrogatories correctly. The user takes affirmative action via an input device to initiate additional advertiser interrogatories and/or advertisements.

If a gamer has answered an interrogatory incorrectly, the gamer will be allowed to answer another interrogatory. If the user elects against earning another gadget, then the user may continue playing the game.

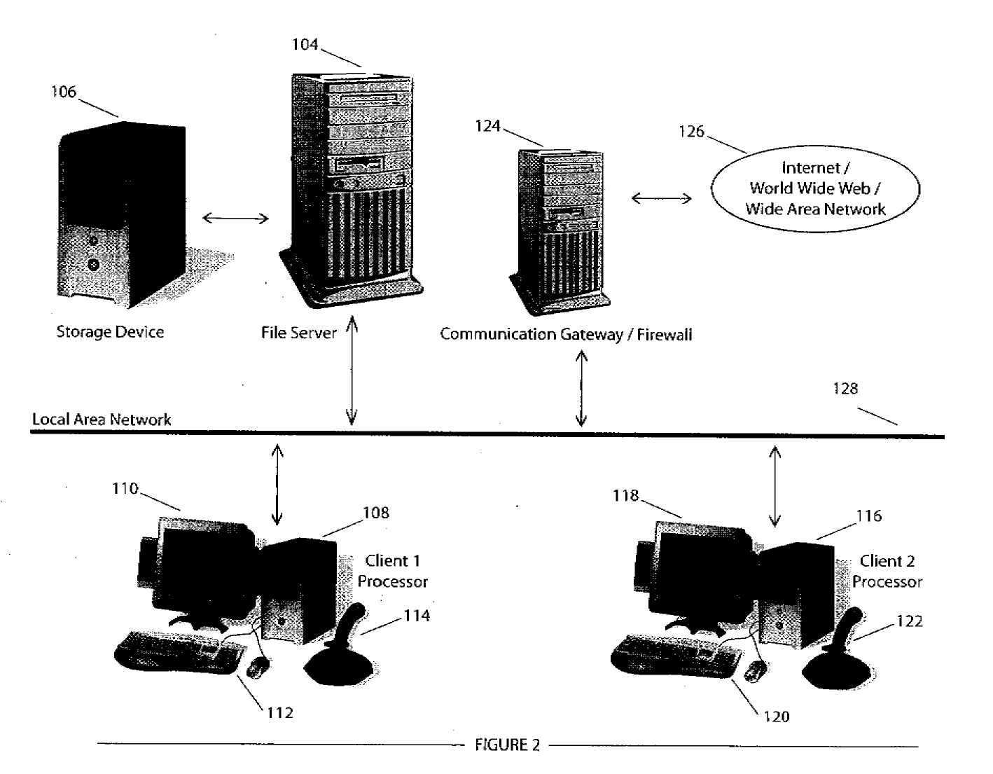

FIG. 2 shows a preferred configuration of processors in an Internet café consistent with the invention. One or more user processors and one or more servers in the Internet café are connected to a LAN 128, either by wire or wirelessly. The LAN is connected via a communication gateway 124, which includes a firewall, to the Internet 126 or other communications network(s) that can access the World Wide Web and/or remote hosts. The communications gateway may be a server connected to one or more processors with Internet access. Some interactive computer games are stored locally on one or more storage devices 106 connected to a file server 104 with LAN connectivity. Some interactive games may run on the file server. A gamer can download other games from the file server to his or her client processor, such as Client 1 Processor 1 108 or Client 2 Processor 116, two out of a multitude of user processors on the LAN. Alternately, part of an interactive game could run on the file server, and one or more client processes for the interactive game can run on each gamer's processor. Each garner sits or stands at a game station, which can be a personal computer. Each gamer has at least one output device 110 and 118, in this case a computer terminal, and one or more input devices, here a keyboard 112, 120 and a joystick 114, 122, connected to the user processor. Since Internet café users will be unlikely to sit at the same personal computer at each visit, their personal files and possibly individual game-related information resides at the file server. The file is connected to one or more storage devices 106, which may physically reside internally in the file server or may reside externally. At intervals, such as during off-business hours, an advertiser from a remote host can upload metrics from the file server and can download new advertisements and query sets, namely sets of questions/interrogatories pertaining to advertised products and services.

Having described the present invention, it will be understood by those skilled in the art that there are many differing embodiments of the invention that will suggest themselves without departing from the scope of the present invention. For example, a computer game requiring correct answers to advertiser interrogatories in order to earn game benefits or gadgets may be hosted or embedded in a variety of devices including, but not limited to, cell phones, interactive television, gasoline pumps, automobiles, kiosks or terminal stations—particularly in areas that require people to wait, movie theaters, and hand-held game machines such as PSPs.

As some of these embodiments suggest, such as hand-held game machines, no metrics will be collected and reported to an advertiser. The advertiser nevertheless benefits from the invention because in order to collect gadgets and reap benefits from the game, the gamer must answer advertising interrogatories correctly, thereby understanding the advertising. In an alternative embodiment for a stand-alone system, the gamer is given the option of contacting the advertising provider through a separate communication means, such as a telephone or computer, to report to redeem gadgets, thereby providing the advertiser with a means to ensure that the advertisement was received and understood.

The computer, input mechanism, display device and storage medium may all be embedded within the same physical container or device. An example is hand-held game machines.

In cases where the metrics of gamer responses are collected and stored, such metrics may be dynamically collected and aggregated in real time. Advertisers may develop “smart” or artificial intelligence applications that dynamically react to the gamer's responses, allowing the advertiser, for example, to download follow-up advertisements or interrogatories targeted to the individual.

A game could be initiated from a remote host. Alternately, a game could run on a local processor off of a local storage medium, such as a CD-ROM, and could automatically and dynamically establish a connection to a remote host on the Internet for the purpose of downloading advertisements and interrogatories and uploading gamer responses to be validated and stored at the remote host.

All of the foregoing modifications are intended to be included within the scope of the invention. The invention may be better defined by the following exemplary claims.

What is claimed is:

1. A method for imparting an in-depth understanding of interactive advertising comprising the steps of:
(a) providing an interactive game to a user;
(b) presenting said user with at least one electronic advertisement while said user is playing said interactive game;
(c) querying said user with at least one interrogatory pertaining to said electronic advertisement;
(d) accepting at least one user response to said interrogatory;
(e) validating at least one said user response;
(f) granting said user at least one reward if at least a sufficient number of correct said user responses is received from said user; and
(g) permitting said reward to confer at least one benefit to said user.

2. The method of claim 1 further comprising maintaining at least one said user response on a storage medium that survives the duration of said interactive game.

3. The method of claim 1 further comprising permitting said user to selectively redeem at least one said reward for at least one said benefit selected from a group comprising at least one gadget, at least one physical prize, at least one virtual prize, a least one discount, and at least one privilege.

4. The method of claim 1 further comprising presenting said user with at least one said electronic advertisement prior to said user playing said interactive game.

5. The method of claim 1 further comprising presenting said user with at least one said electronic advertisement after said user completes playing said interactive game.

6. The method of claim 1 further comprising combining said electronic advertisement with said interrogatory so that the advertising message is clear from said interrogatory or potential answers to said interrogatory.

7. The method of claim 1 further comprising allowing said user to accumulate at least one said reward prior to the start of said interactive game.

8. The method of claim 1, wherein said electronic advertisement is a marketing insert to aid in determining at least one opinion of said user.

9. The method of claim 1 further comprising charging an advertiser for displaying said electronic advertisement based on the number of times that said user correctly answers said interrogatory or a plurality of said interrogatories pertaining to said electronic advertisement.

10. The method of claim 1 further comprising electronically publishing to gamers the fame of said user based on the number and/or type of said gadgets that said user has earned.

11. The method of claim 1 further comprising providing a clue to said user to aid said user in answering said interrogatory.

12. An apparatus for imparting an in-depth understanding of an electronic advertising message to a computer user, said apparatus comprising:
a computer;
a display device that interfaces to said computer; and
an input mechanism that interfaces to said computer;
wherein said computer user who plays a game on said computer is offered a benefit to the playing of said game if said computer user correctly answers via said input mechanism at least one interrogatory relating to said electronic advertising message that appears on said display device.

13. The apparatus of claim 12 wherein said apparatus additionally includes a storage device that interfaces to said computer and stores the responses from said computer user to at least one said interrogatory.

14. The apparatus of claim 12 wherein said apparatus additionally includes said storage device that interfaces to said computer and stores part or all of said electronic advertising message, said interrogatory, and/or said responses from said computer user to at least one said interrogatory.

15. The apparatus of claim 12 wherein said display device and said input mechanism are combined into the same device.

16. The apparatus of claim 12 wherein said computer is embedded with said display device and said input mechanism.
